(19) United States
(12) Patent Application Publication
(10) Pub. No.: US 2018/0167327 A1
(43) Pub. Date: Jun. 14, 2018

(54) PROGRESSIVE CONTENT UPLOAD IN A CONTENT DELIVERY NETWORK (CDN)

(71) Applicant: Level 3 Communications, LLC, Broomfield, CO (US)

(72) Inventor: Christopher Newton, Westlake Village, CA (US)

(21) Appl. No.: 15/378,608

(22) Filed: Dec. 14, 2016

(51) Int. Cl. H04L 12/813; H04L 12/911; H04L 29/08

(52) U.S. Cl. CPC H04L 47/20; H04L 67/02; H04L 67/18; H04L 47/82

(57) ABSTRACT

A computer-implemented method, in a content delivery (CD) network, wherein the CD network delivers content on behalf of multiple content providers. The method includes, at an edge server in the CD network: receiving, from a client, uploaded content for a particular content provider; and determining that the particular content provider is a subscriber to the CD network. Based on the determining, when the particular content provider is determined to be a subscriber to the CD network, uploading the content from the edge server to multiple origin server platforms (OSPs), the uploading being based on at least one policy associated with the particular content provider.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### Field of the Invention

This invention relates to content delivery and content delivery networks. More specifically, this invention relates to progressive content upload in content delivery networks (CDNs).

### BACKGROUND

### Brief Description of the Drawings

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of an exemplary content delivery network (CDN) according to exemplary embodiments hereof;

FIG. 2 depicts aspects of a caching system of the CDN according to exemplary embodiments hereof;

FIG. 3 depicts aspects of progressive content upload according to exemplary embodiments hereof;

FIG. 4 is a flowchart showing aspects of the system according to exemplary embodiments hereof;

FIG. 5 shows aspects of a data structure according to exemplary embodiments hereof; and

FIG. 6 depicts aspects of computing according to exemplary embodiments hereof.

### DETAILED DESCRIPTION OF THE PRESENTLY PREFERRED EXEMPLARY EMBODIMENTS

### Glossary

As used herein, unless used otherwise, the following terms or abbreviations have the following meanings:

CD means content delivery;

CDN or CD network means content delivery network;

DNS means domain name system;

FQDN means Fully Qualified Domain Name;

HTTP means Hyper Text Transfer Protocol;

IP means Internet Protocol;

IPv4 means Internet Protocol Version 4;

IPv6 means Internet Protocol Version 6;

IP address means an address used in the Internet Protocol, including both IPv4 and IPv6, to identify electronic devices such as servers and the like;

OSP means origin server platform;

URI means Uniform Resource Identifier;

URL means Uniform Resource Locator; and

A “mechanism” refers to any device(s), process(es), routine(s), service(s), module(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### DESCRIPTION

A content delivery network (CDN) distributes content (e.g., resources) efficiently to clients on behalf of one or more content providers, preferably via a public Internet. Content providers provide their content (e.g., resources) via origin sources (origin servers or origins). A CDN can also provide an over-the-top transport mechanism for efficiently sending content in the reverse direction—from a client to an origin server. Both end-users (clients) and content providers benefit from using a CDN. Using a CDN, a content provider is able to take pressure off (and thereby reduce the load on) its own servers (e.g., its origin servers). Clients benefit by being able to obtain content with fewer delays.

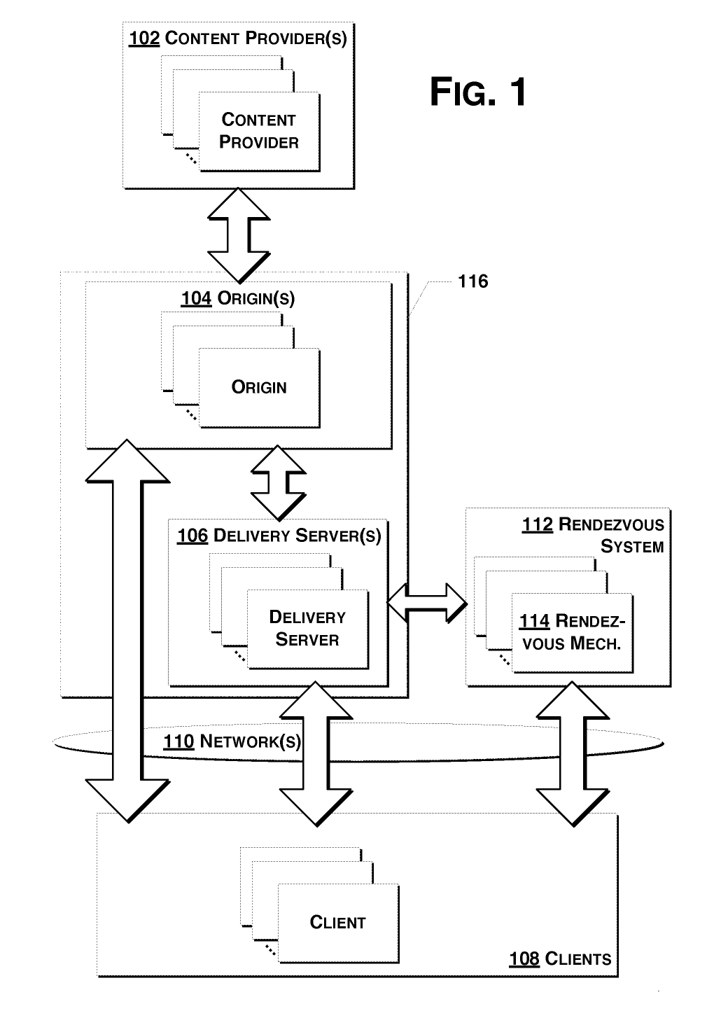

FIG. 1 shows aspects of an exemplary CDN in which one or more content providers 102 provide content via one or more origin sources 104 and delivery services (servers) 106 to clients 108 via one or more networks 110. The delivery services (servers) 106 may form a delivery network from which clients 108 may obtain content. The delivery services 106 may be logically and/or physically organized hierarchically and may include edge caches. The origin sources 104 may be referred to as origin server platforms (OSPs).

As should be appreciated, components of a CDN (e.g., delivery servers or the like) may use the CDN to deliver content to other CDN components. Thus a CDN component may itself be a client of the CDN. For example, the CDN may use its own infrastructure to deliver CDN content (e.g., CDN control and configuration information) to CDN components.

Client requests (e.g., for content) may be associated with delivery server(s) 106 by a rendezvous system 112 comprising one or more rendezvous mechanism(s) 114, possibly in the form of one or more rendezvous networks. The rendezvous mechanism(s) 114 may be implemented, at least in part, using or as part of a DNS system, and the association of a particular client request (e.g., for content) with one or more delivery servers may be done as part of DNS processing associated with that particular client request (e.g., DNS processing of a domain name associated with the particular client request).

As should be appreciated, typically, multiple delivery servers 106 in the CDN can process or handle any particular client request for content (e.g., for one or more resources). Preferably the rendezvous system 112 associates a particular client request with one or more “best” or “optimal” (or “least worst”) delivery servers 106 (or clusters) to deal with that particular request. The “best” or “optimal” delivery server(s) 106 (or cluster(s)) may be one(s) that is (are) close to the client (by some measure of network cost) and that is (are) not overloaded. Preferably the chosen delivery server(s) 106 (or cluster(s)) (i.e., the delivery server(s) or cluster(s) chosen by the rendezvous system 112 for a client request) can deliver the requested content to the client or can direct the client, somehow and in some manner, to somewhere where the client can try to obtain the requested content. A chosen delivery server 106 (or cluster) need not have the requested content at the time the request is made, even if that chosen delivery server 106 (or cluster) eventually serves the requested content to the requesting client.

Exemplary CDNs are described in U.S. Pat. Nos. 8,060,613 and 8,825,830, the entire contents of both of which are fully incorporated herein by reference in their entirety and for all purposes.

The rendezvous system 112 may be implemented, at least in part, as described in U.S. Pat. No. 7,822,871 titled “Configurable Adaptive Global Traffic Control And Management,” filed Sep. 30, 2002, issued Oct. 26, 2010.

The origin(s) 104 and delivery server(s) 106 may sometimes be referred to as cache service network (or caches) 116, where the term “cache” also covers streaming and other internal CDN services. Caches may be organized in various ways. Exemplary cache service network organizations are described in U.S. Pat. Nos. 8,060,613 and 8,825,830, the entire contents of both of which are fully incorporated herein by reference in their entirety and for all purposes.

A CDN may have one or more tiers of caches, organized hierarchically. The term “hierarchically” means that the caches in a CDN may be organized in one or more tiers. The term “hierarchically” is not intended to imply that each cache service is only connected to one other cache service in the hierarchy. Depending on policies, each cache may communicate with other caches in the same tier and with caches in other tiers.

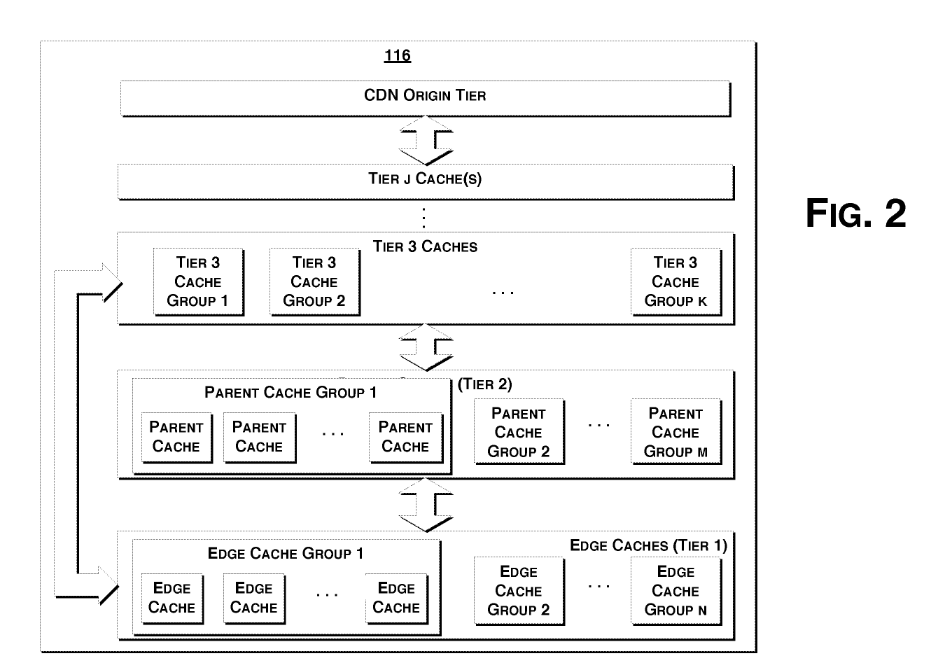

FIG. 2 depicts a cache service network 116 of a content delivery network that includes multiple tiers of caches. Specifically, the cache service network 116 of FIG. 2 shows j tiers of caches (denoted Tier 1, Tier 2, Tier 3 . . . Tier j in the drawing). Each tier of caches may comprise a number of caches organized into cache groups. A cache group may correspond to a cache cluster site or a cache cluster. The Tier 1 caches are also referred to as edge caches and Tier 1 is sometimes also referred to as the “edge” or the “edge of the CDN.” The Tier 2 caches (when present in a CDN) may be referred to as parent caches.

For example, in the cache service network 116 of FIG. 2, Tier 1 has n groups of caches (denoted “Edge Cache Group 1”, “Edge Cache Group 2”, . . . “Edge Cache Group n”); tier 2 (the parent caches' tier) has m cache groups (the i-th group being denoted “Parent Caches Group i”); and tier 3 has k cache groups, and so on. There may be any number of cache groups in each tier, and any number of caches in each group. The origin tier is shown in the FIG. 2 as a separate tier, although it may also be considered to be tier (j+1). The origin tier may correspond to origin servers 104 in FIG. 1.

Each cache group may have the same or a different number of caches. Additionally, the number of caches in a cache group may vary dynamically. For example, additional caches may be added to a cache group or to a tier to deal with increased load on the group. In addition, a tier may be added to a cache service network. The addition of a cache to a tier or a tier to a cache service network may be accomplished by a logical reorganization of the cache service network, and may not require any physical changes to the cache service network.

While no scale is applied to any of the drawings, in particular implementations, there may be substantially more edge caches than parent caches, and more parent caches than tier 3 caches, and so on. In general, in preferred implementations, each tier (starting at tier 1, the edge caches) will have more caches than the next tier (i.e., the next highest tier number) in the hierarchy. Correspondingly, in preferred implementations, there will be more caches in each edge cache group than in the corresponding parent cache group, and more caches in each parent cache group than in the corresponding tier 3 cache group, and so on.

The caches in a cache group may be homogeneous or heterogeneous, and each cache in a cache group may comprise a cluster of physical caches sharing the same name and/or network address. Examples of such caches are described in U.S. Pat. No. 8,489,750, issued Jul. 16, 2013, titled “Load-Balancing Cluster,” and U.S. Pat. No. 8,015,298, titled “Load-Balancing Cluster,” issued Sep. 6, 2011, the entire contents of both of which are fully incorporated herein by reference for all purposes.

A CDN with only one tier will have only edge caches, whereas a CDN with two tiers will have edge caches and parent caches. (At a minimum, a CDN should have at least one tier of caches—the edge caches.)

The grouping of caches in a tier may be based, e.g., on one or more factors, such as, e.g., their physical or geographical location, network proximity, the type of content being served, the characteristics of the machines within the group, etc. For example, a particular CDN may have six groups—four groups of caches in the United States, Group 1 for the West Coast, Group 2 for the mid-west, Group 3 for the northeast, and Group 4 for the southeast; and one group each for Europe and Asia.

A particular cache is preferably in only one cache group and only one tier.

With reference to FIG. 1, a CDN may provide aspects of a content delivery system to deliver content from a content source (e.g., a content provider 102) to a client 108 via a caching services network 116 (comprising, e.g., delivery servers 106 and origin servers 104). In some aspects, a CDN may act as an object upload system, providing content from clients 108 to origin servers 104 via the caching services network 116.

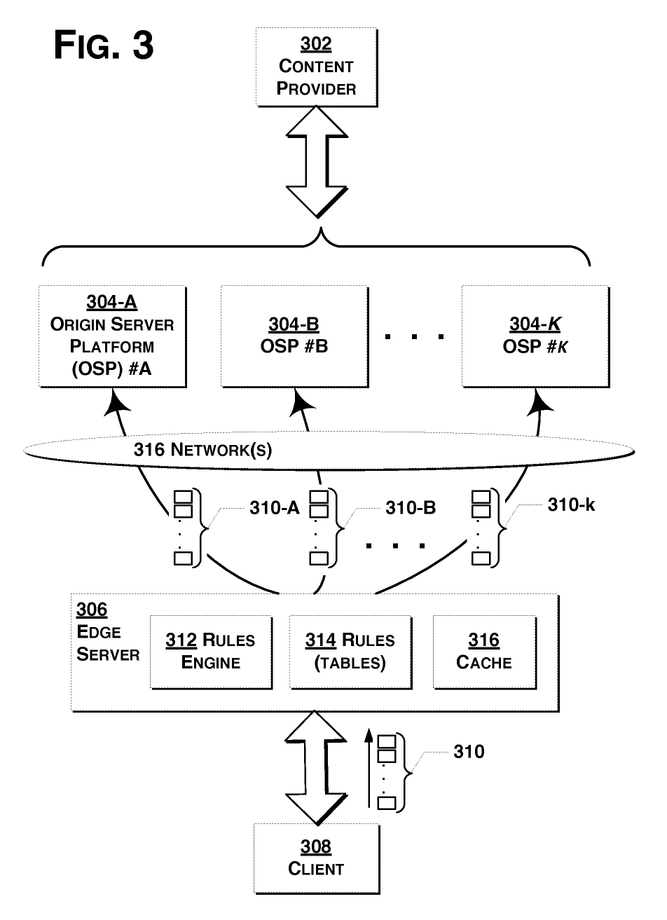

For example, as shown in FIG. 3, a CDN may provide aspects of a content upload system to provide content from a client 308 to a content provider 302 or to one or more origin server platforms 304. Since (as noted above) components of a CDN (e.g., delivery servers or the like) may use the CDN to deliver content to other CDN components, the client 308 may be or correspond to an arbitrary component of the CDN (e.g., a content provider 102, an origin source 104, a delivery sever 106, or a CDN client 108).

In operation, with reference to the example shown in FIG. 3, client 308 issues an HTTP PUT (or POST) command in order to provide content 310 to a content provider via the caching services network 116. This PUT/POST may have been issued, e.g., via a website associated with the content provider 302 (e.g., to upload a video or document or the like). The content 310 may be any content that can be uploaded, and the system is not limited by the size of the content or what it may represent.

An HTTP PUT (or POST) command has a URI (or URL) associated therewith, where the URI (or URL) includes a hostname or fully qualified domain name—FQDN). The rendezvous system is invoked when the client tries to resolve the hostname associated with the PUT (or POST) command. The remainder of this description will refer to an HTTP PUT command, although it should be appreciated that an HTTP POST command or some other command may be used to upload the content 310. The approach described herein may be used for other methods that affect content held at locations with the content delivery network; e.g., a DELETE may be similarly spread across multiple targets (as could PATCH, etc.). As should be appreciated, in some such cases (e.g., DELETE, PATCH), the command would more normally want to go to all configured OSPs and not to just a quorum.

The rendezvous system provides the client with an address (e.g., a network address such as an IP address) corresponding to the then “best” or “optimal” server in the caching services network 116 (e.g., edge server 306).

The client connects to that particular edge server 306 and attempts to upload the content 310 (e.g., in the form of packets or chunks or blocks).

A rules engine 312 in the edge server 306 checks that a hostname associated with the upload command (e.g., the PUT command) is associated with a particular content provider associated with the CDN. For example, the edge server's rules engine 312 may check that a hostname associated with the PUT command is associated with a subscriber to the CDN. The rules engine 312 may use rules 314 including, e.g., subscriber tables, to determine whether to allow the upload.

If the PUT command is not associated with a content provider associated with the CDN then the upload is not permitted, otherwise the client 308 PUTs the content 310 to the edge server 306.

Since the content 310 is intended for a content provider 302 or an origin server platform (OSP), the edge server (e.g., the rule engine 312) attempts to determine which OSP(s) should get a copy of the content 310. The edge server 306 may store some or all of the content 310 in a cache 316 (even if a PUT or POST does not require caching).

The uploaded content 310 is sent from the edge server 306 to multiple origin server platforms 304 (e.g., via caching networks 316 which may correspond, e.g., to at least some of network 116 in FIG. 2).

The rules engine 312 determines which (and how many) origin server platforms 304 to upload the content 310 to based, e.g., on rules 314. For example, the rules engine 312 in the edge server 306 may lookup the content provider name in a table in the rules 314 to get identities of the OSPs 304 that should get copies of the content 310. The rules may require that all specified OSPs get a copy, or that at least a specified quorum of the OSPs get a copy.

The edge server 306 then provides (e.g., via a PUT or POST) the content 310 to each of various OSPs 304. In the example in FIG. 3, the edge server 306 provides the content 310 as content 310-A to origin server platform #A (304-A); and as content 310-B to origin server platform #B (304-B); and so in, including as content 310-k to origin server platform #k (304-k). The various uploads of content 310-j to OSP #j (304-j) (for j=1 . . . k) may occur in parallel or in series or in combinations thereof. If any of the k uploads fail then they may be restarted or terminated if sufficient uploads have already been successful. For example, if the rules 314 require that all (k out of k) uploads succeed, then any unsuccessful uploads are retried. On the other hand, if the rules 314 require some ratio (e.g., m out of k, m<k) uploads to succeed, then the edge server can terminate (or not restart) any unfinished uploads after m have succeeded. Preferably uploads that do not fail are allowed to run to completion, even if sufficient uploads have already succeeded.

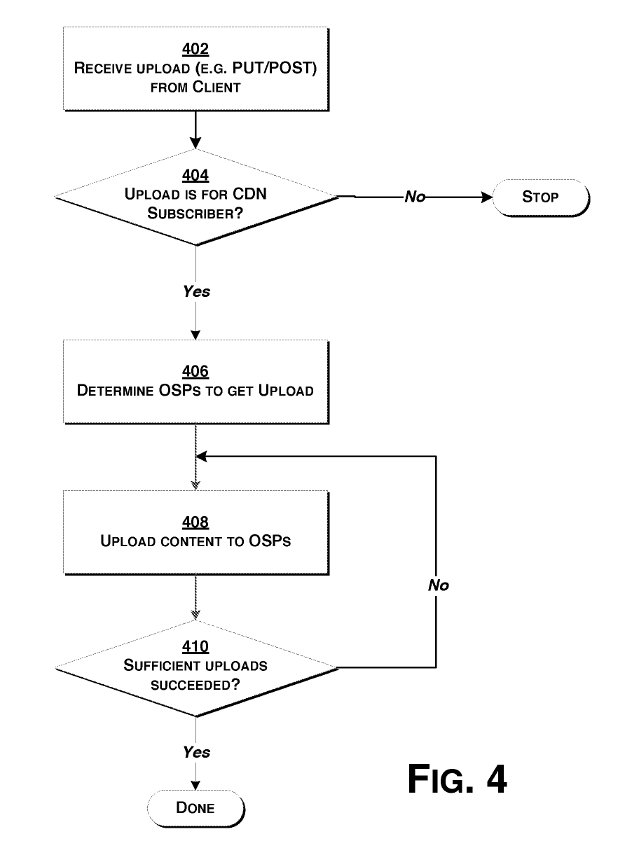

Exemplary processing by an edge server 306 is described with reference to the flowchart in FIG. 4. The edge server 306 receives an upload request (e.g., PUT or POST) from client 308 (at 402). The edge server 306 then determines (at 404) whether the requested upload is for a CDN subscriber. For example, the request preferably includes a hostname (e.g., a fully qualified domain name) and the edge server 306 may determine whether the hostname corresponds to a CDN subscriber. The determination (at 404) may be made by the rules engine 312 using rules (including subscriber tables) 314 in or available to the edge server 306.

If the edge server 306 determines (at 404) that the upload is not for a subscriber to the CDN then the upload is terminated, otherwise the edge server 306 determines (at 406) which (and/or how many) OSPs should get a copy of the upload. The edge server 306 may determine the identity of the OSPs (and/or how many OSPs) to get a copy using the rules engine 312 and rules 314. The rules 314 may specify one or more hostnames for the OSP(s), and the edge server 306 may use the rendezvous system 112 (FIG. 1), to get network addresses (e.g., IP address) for the OSPs 304. In some cases the rendezvous system 112 may return multiple network addresses for the OSPs 304, and the edge server 306 will upload the content 310 to a sufficient number of those OSPs 304, where the number may be specified in the rules 314 and may require upload to all OSPs 304 identified by the rendezvous system. For example, the rules may require that the content is copied to at least four OSPs and the rendezvous system may return six IP addresses (corresponding to six OSPs). In that case the rules will be satisfied if the content is successfully uploaded to any 4 of the 6 OSPs. If not specified by the rules, the content must be uploaded to all OSPs identified by the rendezvous system.

Having determined OSPs to get uploads (at 406), the edge server 306 begins uploading the content to those OSPs (at 408). As noted above, the uploads may be in parallel, or sequential, or some combination thereof.

The edge server 306 determines (at 410) if sufficient uploads have been successful, based on the requirements of the rules 314 (including any default rules), as interpreted, e.g., by the rules engine 312. If the edge server determines that sufficient uploads have been successful, then processing is done, otherwise processing continues (at 408), uploading the content to the OSPs.

The edge server 306 may begin uploading the content 310 to the various OSPs as that content is being received form the client 308, or it may stage the delivery, e.g., saving the uploaded content 310 in a cache 316 until the some or all of the content 310 has been received from the client. The decision as to when to upload may be included in the rules 314 and may depend on the identity of the content provider 302 for whom the content is being uploaded.

As described, a push is done directly from the edge to the OSP. Those of ordinary skill in the art will realize and appreciate, upon reading this description, that a transfer to an OSP may be performed via higher tiers in the content delivery network, each of which may decide to send each incoming PUT/POST to multiple targets in the next tier.

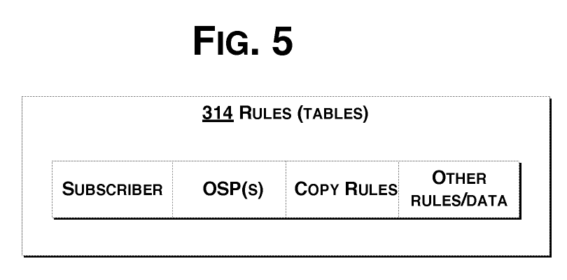

Exemplary rules 314 are shown in FIG. 5, and may include a mapping from subscribers to OSPs, copying rules, and other rules and/or data for that subscriber. For example, for each CDN subscriber, the OSPs may list one or more hostnames for OSPs for that subscriber. The rendezvous system may be used to resolve those hostnames. The copying rules for each CDN subscriber (if specified), may indicate the number of copies of the content that are required to be uploaded to the specified OSPs. The number of copies may be specified as a number, a ratio, or a percentage. If unspecified, the number of copies may default to a system default (e.g., 2 copies, 3 copies, 5 copies, etc.). The other rules/data may be used by the rules engine 312.

The rules may be set, at least in part, by the content providers and/or may be determined from default rules and/or policies. For example, a default policy may be for the edge server to upload the content received from a client to at least two (2) OSPs. A subscriber (or the CDN operator) may override the policy. The rules may specify specific OSPs and/or geographical regions where the OSPs reside. For example, a policy of a particular CDN subscriber (SUB1) may require content to be replicated on at least three (3) OSPs, with one in the USA, one in Japan, and one in Europe. The CDN may then select three OSPs that match those criteria and enforce those criteria via one or more rules. In such a case, the rules 314 may list the subscriber “SUB1” and the three OSPs “USA-OSP.CDN.NET”, “JP-OSP.CDN.NET,” and “EU-OSP.CDN.NET” as OSPs. When doing an upload for a client to subscriber SUB1, the edge server 306 will determine (at 406, using the rules 314) to use these three OSPs.

The client may access the edge server using an alias for the subscriber, and the subscriber tables or rules may map this alias to the subscriber.

### Computing

The services, mechanisms, operations and acts shown and described above are implemented, at least in part, by software running on one or more computers of a CDN.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

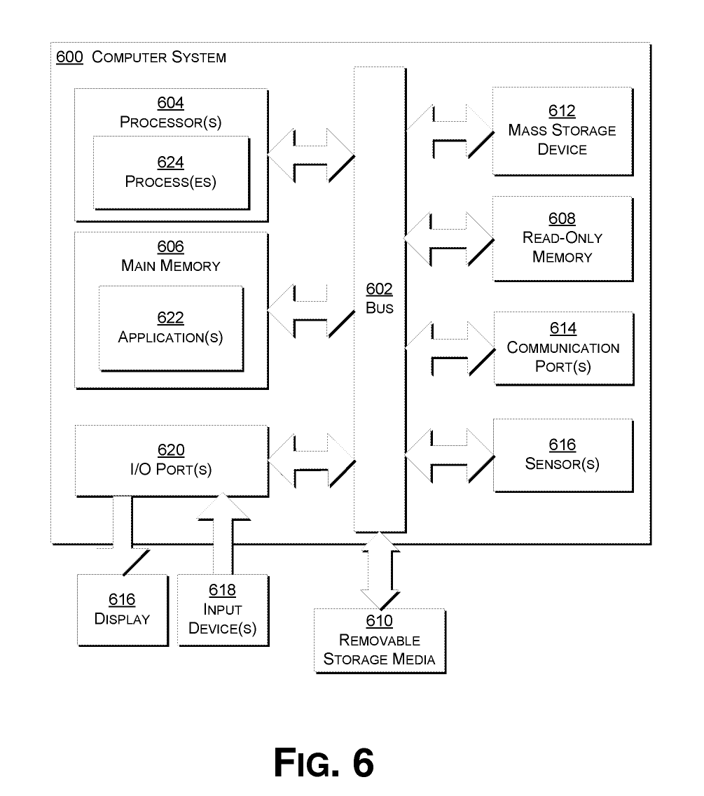

FIG. 6 is a schematic diagram of a computer system 600 upon which embodiments of the present disclosure may be implemented and carried out.

According to the present example, the computer system 600 includes a bus 602 (i.e., interconnect), one or more processors 604, a main memory 606, read-only memory 608, removable storage media 610, mass storage 612, and one or more communications ports 614. Communication port 614 may be connected to one or more networks by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an RS-232 port for use with a modem based dial-up connection, a 10/100 Ethernet port, a Gigabit port using copper or fiber, or a USB port, and the like. Communications port(s) 614 may be chosen depending on a network such as a Local Area Network (LAN), a Wide Area Network (WAN), a CDN, or any network to which the computer system 600 connects. The computer system 600 may be in communication with peripheral devices (e.g., display screen 616, input device(s) 618) via Input/Output (I/O) port 620.

Main memory 606 can be Random Access Memory (RAM), or any other dynamic storage device(s) commonly known in the art. Read-only memory 608 can be any static storage device(s) such as Programmable Read-Only Memory (PROM) chips for storing static information such as instructions for processor 604. Mass storage 612 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 602 communicatively couples processor(s) 604 with the other memory, storage, and communications blocks. Bus 602 can be a PCI/PCI-X, SCSI, a Universal Serial Bus (USB) based system bus (or other) depending on the storage devices used, and the like. Removable storage media 610 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 606 is encoded with application(s) 622 that supports the functionality discussed herein (the application 622 may be an application that provides some or all of the functionality of the CD services described herein, including rendezvous services). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service related to the application(s). In other words, the process(es) 624 represent one or more portions of the application(s) 622 performing within or upon the processor(s) 604 in the computer system 600.

It should be noted that, in addition to the process(es) 624 that carries (carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application 622 may also be stored in removable storage media 610, read-only memory 608 and/or mass storage device 612.

Those skilled in the art will understand that the computer system 600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some services” means “one or more services”, and includes the case of one service.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of CDN services” may include one or more CDN services.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A computer-implemented method, in a content delivery (CD) network, wherein said CD network delivers content on behalf of multiple content providers, the method comprising, at an edge server in the CD network:
(A) receiving, from a client, uploaded content for a particular content provider;
(B) determining that said particular content provider is a subscriber to the CD network;
(C) based on said determining in (B), when said particular content provider is determined to be a subscriber to the CD network, uploading said content from said edge server to multiple origin server platforms (OSPs), said uploading being based on at least one policy associated with said particular content provider.

2. The method of claim 1 wherein, based on said at least one policy, said uploading in (C) is staged.

3. The method of claim 1 wherein, based on said policy, said uploading in (C) begins while said content is still being upload from said client.

4. The method of claim 1 wherein said multiple origin server platforms are specified in said at least one policy.

5. The method of claim 4 wherein said multiple origin servers are specified as one or more hostnames or fully qualified domain names (FQDNs) in said at least one policy.

6. The method of claim 5 wherein said CD network comprises a rendezvous system and wherein said edge server uses to rendezvous system to resolve said one or more hostnames or FQDNs.

7. The method of claim 6 wherein said rendezvous system comprises a domain name system (DNS).

8. The method of claim 1 wherein the number of said OSPs is based on said at least one policy.

9. The method of claim 8 wherein said number is specified as a ratio or as a percentage.

10. The method of claim 1 wherein said multiple OSPs comprise two OSPs.

11. The method of claim 1 wherein said OSPs are selected based on geographical locations of said OSPs.

12. The method of claim 1 wherein said client is connected to said edge server using a particular hostname for said particular content.

13. The method of claim 12 wherein said CD network comprises a rendezvous system and wherein client used said rendezvous system to resolve said particular hostname.

14. The method of claim 1 wherein said uploading in (C) uses HTTP PUT or POST commands for said multiple OSPs.

15. An article of manufacture comprising a computer-readable non-transitory medium having program instructions stored thereon, the program instructions, operable on a computer system in a content delivery network (CDN), said device implementing at least one content delivery (CD) service, wherein execution of the program instructions by one or more processors of said computer system causes the one or more processors to carry out the acts of:
(A) receiving, from a client, uploaded content for a particular content provider;
(B) determining that said particular content provider is a subscriber to the CD network;
(C) based on said determining in (B), when said particular content provider is determined to be a subscriber to the CD network, uploading said content from said edge server to multiple origin server platforms (OSPs), said uploading being based on at least one policy associated with said particular content provider.

16. The article of manufacture of claim 15 wherein, based on said at least one policy, said uploading in (C) is staged.

17. The article of manufacture of claim 15 wherein, based on said policy, said uploading in (C) begins while said content is still being upload from said client.

18. A device in a content delivery network (CDN), wherein said CDN delivers content on behalf of at least one content provider, said device implementing a content delivery (CD) service, the device:
(A) receiving, from a client, uploaded content for a particular content provider;
(B) determining that said particular content provider is a subscriber to the CD network;
(C) based on said determining in (B), when said particular content provider is determined to be a subscriber to the CD network, uploading said content from said edge server to multiple origin server platforms (OSPs), said uploading being based on at least one policy associated with said particular content provider.

19. The device of claim 18 wherein, based on said at least one policy, said uploading in (C) is staged.

20. The device of claim 18 wherein, based on said policy, said uploading in (C) begins while said content is still being upload from said client.
